(19) United States
(12) Patent Application Publication
(10) Pub. No.: US 2006/0287467 A1
(43) Pub. Date: Dec. 21, 2006

(54) Soluble polyimide resin and method of preparing the same

(76) Inventors: Kuen-Yuan Hwang, Hsinchu (TW); An-Pang Tu, Hsinchu (TW); Sheng-Yen Wu, Hsinchu (TW)

Correspondence Address: FULBRIGHT AND JAWORSKI LLP, 555 S. FLOWER STREET, 41ST FLOOR, LOS ANGELES, CA, 90071, US

(21) Appl. No.: 11/441,662

(22) Filed: May 26, 2006

(30) Foreign Application Priority Data
May 30, 2005 (TW) 094117630

(51) Int. Cl. C08G 73/00

(52) U.S. Cl. 528/170

(57) ABSTRACT

The present invention provides a polyimide resin, which is prepared by epolycondensing a dianhydride monomer including at least a dianhydride represented by formula (I) 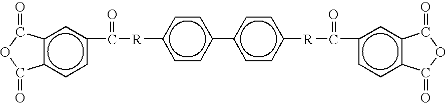
wherein R is O or O(CH₂)ₙO, n is an integer of 1 to 2 and a diamine monomer represented by formula (II)
   H₂N—Ar—NH₂ (II) wherein Ar is defined as in the text then imidizing the resulting polyamic acid resin to form a polyimide resin. Through using the dianhydride represented by formula (I) as the polymerizing unit, a biphenyl moiety and an ester moiety are introduced into the main chain of the polyimide resin, such that the resulting polyimide resin has lower moisture absorption and smaller linear thermal expansion coefficient and therefore have satisfactory heat resistance and dimensional stability, in addition, become more soluble in organic solvents.

### FIELD OF THE INVENTION

The present invention relates to a polyimide resin, especially a soluble polyimide resin and method of preparing the same.

### BACKGROUND OF THE INVENTION

Recently, with the increasing demand for miniaturization of electronic and communication devices, the integrated circuit packages therein tend to become smaller and thinner and circuits also become finer. Among various types of printed circuit boards, flexible printed circuit boards are widely used because they can greatly reduce the volume and the weight of an electronic device.

Generally, a flexible printed circuit board comprises an insulating substrate and a metal layer. The insulating substrate is adhered to the metal layer by an adhesive. The metal layer is usually consisting of a copper foil. Polyimide resins are widely used as insulating substrates due to their good heat resistance, chemical resistance, and excellent mechanical and electrical properties. The adhesives for bonding the insulating substrate and the metal layer are usually epoxy resins or acrylic resins. However, these adhesives have poor heat resistance and hence easily cause cracking during the sequential step of curing resin, which in turn results in reduction of the dimension stability of the printed circuit boards. To solve this problem, it has been attempted to incorporate a rubber elastomer into the adhesive to prevent the occurrence of cracking. Nevertheless, rubber elastomers have poor heat stability and will degrade during high temperature process, which in turn will result in lowering the physical properties of flexible printed circuit boards (FPC).

The properties of the polyimide resin adhesive layer itself will affect the quality of the laminated plate. When a polyimide resin contains more amide groups, moisture absorption will increase and decomposition of amide groups into amino groups and acid groups may occur. Introduction of some other functional groups into main chain of polyimide resin may reduce moisture absorption. However, higher ratio of long-chain monomers may decrease elasticity and increase linear thermal expansion coefficient of polyimide resin layer, leading to lower dimensional stability of the laminated plate prepared therefrom. Moreover, polyimide resin is usually insoluble in organic solvents, which greatly limits its applications.

Therefore, there is still a demand for soluble polyimide resin that has reduced moisture absorption, smaller linear thermal expansion coefficient, and good heat resistance and processability.

### SUMMARY OF THE INVENTION

One object of the present invention is to provide a polyimide resin soluble in organic solvents.

Another object of the present invention is to provide a polyimide resin with high dimensional stability.

Still another object of the present invention is to provide a polyimide resin with excellent heat resistance.

In order to achieve above purposes and other purposes, the present invention provides a polyimide resin, which is prepared by polycondensating, a dianhydride monomer including at least a dianhydride represented by formula (I)

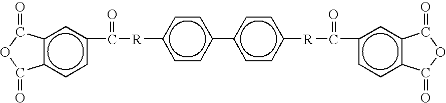

wherein R is O or O(CH₂)ₙO, n is an integer of 1 to 2 and a diamine monomer including at least a diamine represented by formula (II)
H₂N—Ar—NH₂ (II)

wherein Ar is an aromatic group selected from the following: 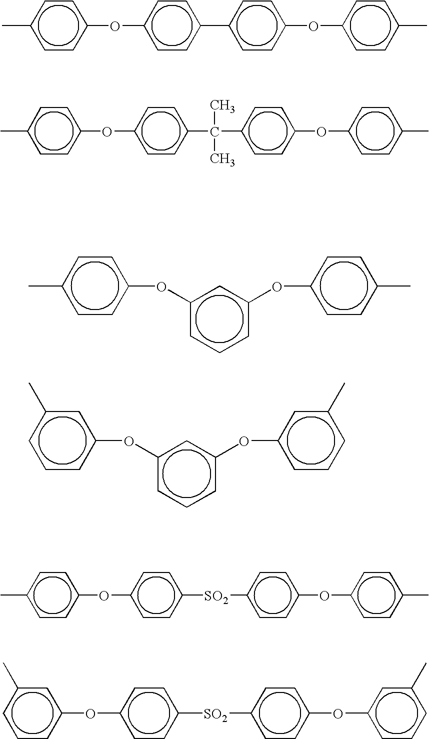
to form a polyamic acid resin, then imidizing the polyamic acid resin.

Through using the dianhydride represented by formula (I) as the polymerizing unit, a biphenyl moiety and an ester moiety are introduced into the main chain of the polyimide resin, such that the resulting polyimide resin has lower moisture absorption and smaller linear thermal expansion coefficient and therefore have satisfactory heat resistance and dimensional stability, in addition, become more soluble in organic solvents.

The present invention further provides a method of preparing polyimide resin, comprising polycondensating a dianhydride monomer including at least a dianhydride represented by formula (I) and a diamine monomer including at least a diamine represented by formula (II) in the presence of an aprotic solvent to form a polyamic acid resin and then imidizing said polyamic acid resin to form a polyimide resin. The polyimide resin of present invention can be dissolved in organic solvent(s) to form a varnish, which is useful as an adhesive for laminated plates and IC packages.

### DETAILED DESCRIPTION OF THE INVENTION

The present invention is now illustrated by the following specific embodiments. Persons skilled in the art can easily realize the advantages and effects of the present invention according to the disclosed contents in the specification. The present invention may be executed or applied with other different embodiments, and any details in the specification may be modified or varied based on different points of view and applications without departing from the spirit of the present invention.

The polyimide resin of the present invention is prepared by polycondensating a dianhydride monomer including at least a dianhydride represented by formula (I)

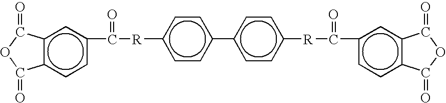

wherein R is O or O(CH₂)ₙO, n is an integer of 1 to 2 and a diamine monomer including at least a diamine represented by formula (II)
H₂N—Ar—NH₂ (II)

wherein Ar is an aromatic group selected from, for example, the following: 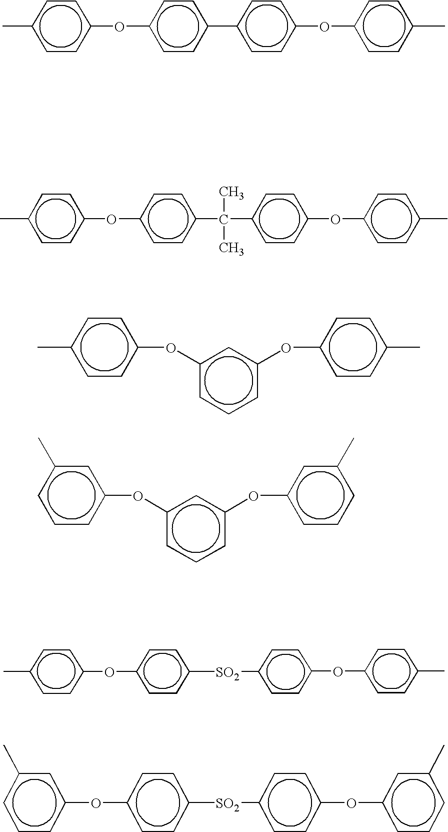
in the presence of an aprotic solvent to form a polyamic acid resin, then imidizing the polyamic acid resin to form a polyimide resin.

Through using the dianhydride monomer represented by formula (I) as the polymerizing unit, ester functional groups are introduced into the main chain of the polyimide resin, resulting in increasing the solubility of the polyimide resin in organic solvents; in addition, biphenyl groups are also introduced into the main chain of the polyimide resin, resulting in reducing moisture absorption and decreasing linear thermal expansion coefficient. As a result, the polyimide resin of the present invention has wider applications due to increased solubility in organic solvents and improved processing stability and dimensional stability due to reduced moisture absorption. Furthermore, the polyimide resin of the present invention has thermal expansion coefficient closer to that of metal layer such as copper foil, and therefore the wiring board produced therefrom will less curled and deformed in a high temperature process, namely will have better dimensional stability.

R in the dianhydride monomer of formula (I) represents O or O(CH₂)ₙO (n is 1 to 2), preferably O or OCH₂CH₂O. The dianhydride monomer of formula (I), when R is O, is called PBTDA; when R is OCH₂CH₂O, is called BHEBPDA.

PBTDA can be prepared by the conventional methods. For example, PBTDA was prepared by reacting trimellitic acid anhydride chloride with a glycol in a solvent such as benzene and toluene. Furthermore, PBTDA can be prepared by condensing trimelltic anhydride (TMA) with 4,4′-dihydroxybiphenyl as shown in Reaction Scheme 1.

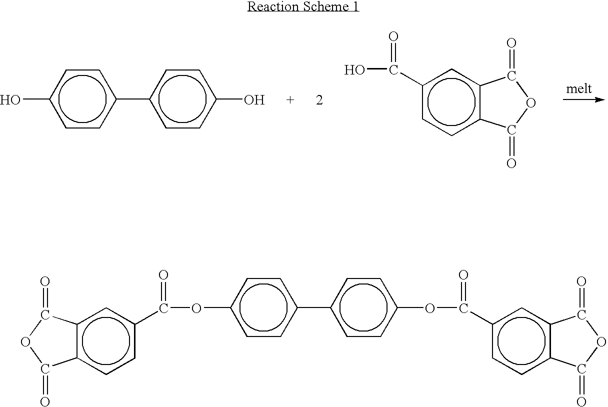

BHEBPDA can be prepared by the conventional methods. For example, Japanese Patent Publication Sho 10-330306 disclosed that BHEBPDA was prepared by condensating TMA with BHEBP (Bis(2-hydroxyethoxy)biphenyl) as shown in Reaction Scheme 2.

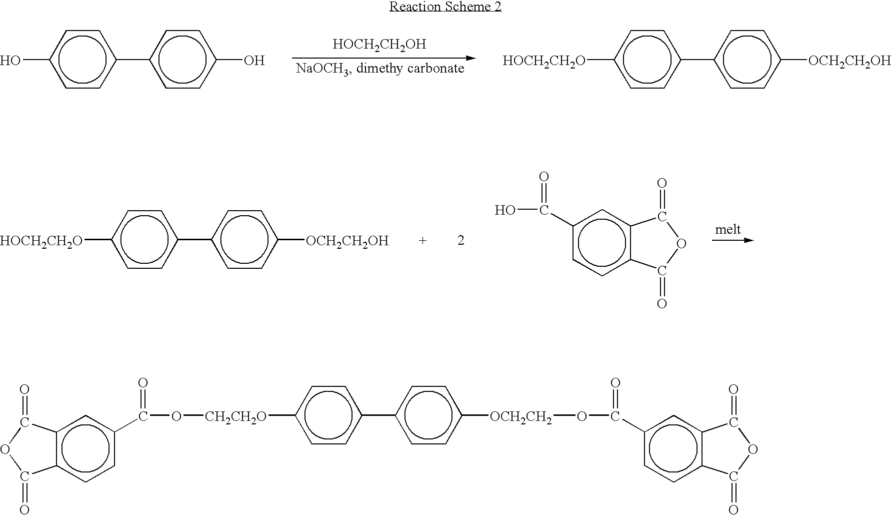

The dianhydride monomers may include, In addition to the dianhydride of formula (I), one or more other dianhydrides including, but not limited to, 3,3′,4,4′-benzophenone-tetracarboxylic dianhydride (BTDA), 3,3′,4,4′-biphenyltetracarboxylic dianhydride (BPDA), and 4,4′-oxydiphthalic anhydride (ODPA).

In a preferred embodiment of the present invention, the dianhydride monomer comprises 5 to 20 mol % of the dianhydride represented by formula (I), 60 to 80 mol % of 3,3′,4,4′-benzophenonetetracarboxylic dianhydride (BTDA), 10 to 20 mol % of carboxylic dianhydride (BPDA) and 5 to 15 mol % of 4,4′-oxydiphthalic dianhydride (ODPA), based on the total moles of the dianhydride monomer.

The diamine monomer used in the present invention may comprise, in addition to the diamine represented by formula (II), one or more other diamines including, but not limited to, 2,2′-bis-[4-(4-aminophenoxy) phenyl]propane (BAPP), 4,4′-bis-(4-aminophenoxy)biphenyl (BAPB), bis[4-(4-aminophenoxy)-phenyl] sulfone (BAPS), 3,3′-Diaminodiphenylsulfone (DDS) and 1,4-bis(4-aminophenoxy)benzene (APB).

In the polyimide resin of the present invention, the molar ratio of dianhydride monomers to diamine monomers is preferably 0.75 to 1.25, and more preferably 0.9 to 1.1.

Polyimide resin of the present invention is prepared as follows. To a solution of a diamine monomer in an aprotic solvent, a solution of a dianhydride monomer in an aprotic solvent are added portionwise to perform polycondensation, thereby forming polyamic acid resin.

Examples of the aprotic solvent suitable use in the polycondensation include, but are not limited to, N-methyl-2-pyrrolidone (NMP), dimethylacetamide (DMAC), dimethylformamide (DMF) and mixtures thereof. Other organic solvents may be added to the aprotic solvent. Said other organic solvents include, but are not limited to, benzene, toluene, cyclohexanol and mixtures thereof. The organic solvent is used in an amount that will not cause precipitation of the polyamic acid resin.

Polycondensation of dianhydride monomers and diamine monomers is performed preferably at a temperature of 0 to 100° C., more preferably 0 to 80° C. The resulting solution of polyamic acid resin preferably has a solid content of 5 to 50% by weight, more preferably 10 to 30% by weight.

Polyamic acid resin is then cyclodehydrated in the presence of triethylamine and acetic anhydride at 100 to 450° C., preferably 150 to 400° C., to form polyimide resin. Alternatively, polyamic acid resin is cyclodehydrated by azeotropic reflux with toluene or xylene to from polyimide resin, followed by adding methanol to precipitate the product, thereby obtaining polyimide resin powder.

Polyimide resin of the present invention can be used in manufacturing flexible printed circuit boards (FPC), wherein polyimide resin layer usually has a thickness of 2 to 100 μm and the metal layer is selected from a copper foil, an aluminum foil, a nickel foil, or an SUS304 foil. The copper foil can be electrolytically deposited copper foil or rolled copper foil, usually with a thickness of 12 to 70 μm. For manufacturing flexible printed circuit boards, the polyamic acid resin is first coated on the matted side of the above metal oil with a die coater, a lip coater, or a roll coater. After coated, the foil is baked in an oven to remove the solvent until the solvent content is less than 20%. The baking temperature is typically 110 to 180° C., preferably 120 to 170° C. The baking speed is typically 0.5 to 10 m/min, preferably 1 to 7 m/min.

The polyamic acid resin is then cured at high temperature, for example, 200 to 400° C., preferably 250 to 350° C.; or cured at lower temperature, for example, 200 to 300° C., in the presence of a tertiary amine or acetic anhydride, thereby forming polyimide resin. Curing is achieved by heating in an oven in a continuous or batch mode. Curing is preferably performed in a nitrogen or inert gas atmosphere to protect metal layer from oxidation during heating process.

The varnish prepared by dissolving polyimide resin powder of the present invention in an aprotic solvent such as NMP, DMAC, or DMF and the like, can be used as an adhesive for bonding polyimide substrates (for example, commercially available Kapton, Apical, or Upilex and the like) and metal foils. Polyimide substrate is coated with the varnish and baked in an oven to remove solvent, and then laminated with a metal foil such as copper foil by pressure to form a flexible printed circuit board (FPC board).

Polyimide resin of the present invention has good heat resistance and high bonding strength, therefore can avoid the disadvantages of poor heat resistance of epoxy resin adhesives or acrylic resin adhesives, which may degraded in a high temperature process, leading to lowering the quality of FPC boards.

The polyimide resin of the present invention can be used as a protective film (shielding film) in a package of electronic means or electronic members, for example, integrated circuit (IC) members or light emitting diode (LED) members. The polyimide resin of the present invention can also be blended with photosensitive compounds to form a photosensitive polyimide resin, which can be used in the process of manufacturing integrated circuits (IC). Moreover, the film or varnish made of the polyimide resin of the present invention can be used to manufacture heat resistant cover films for use in flexible printed circuit boards. The polyimide resin of the present invention can also be blended with a compound having high dielectric constant such as barium titanate to manufacture embedded electronic members such as capacitors.

The following examples are provided to further illustrate the features and effects of the present invention. The details of the examples are only used to illustrate the present invention but not to limit the scope of the invention.

### EXAMPLES

### Raw Materials used in Examples

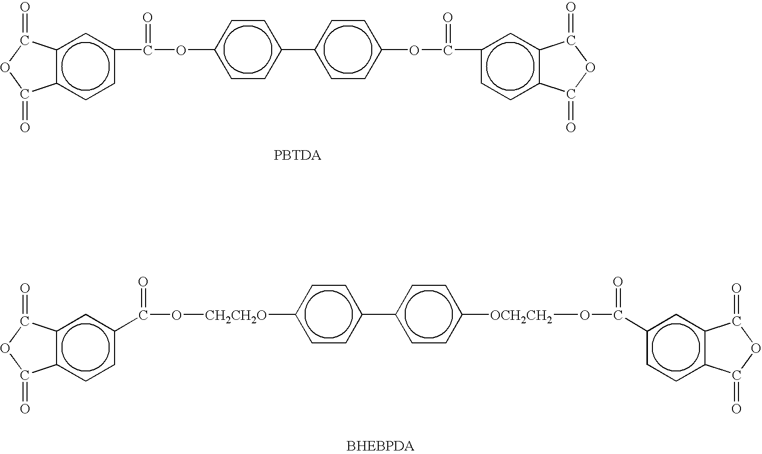

BTDA: 3,3′,4,4′-benzophenonetetracarboxylic acid dianhydride

BPDA: 3,3′,4,4′-biphenyltetracarboxylic acid dianhydride

ODPA: 4,4′-oxydiphthalic dianhydride

TPE-R: 1,3-bis(4-aminophenoxy)benzene

BAPP: 2,2′-bis-[4-(4-aminophenoxy)phenyl]propane

BAPS: bis [4-(4-aminophenoxy)phenyl]sulfone

APB: 1,4-bis(4-aminophenoxy)benzene

BAPB: 4,4′-bis(4-amino phenoxy)biphenyl

NMP: N-methyl-2-pyrrolidone

DMAC: dimethylacetamide

DMF: dimethylformamide

Test Method of Physical Properties

(1) Solder float resistance test: performed according to IPC TM-650 2. 4. 13

(2) Peeling strength: measured according to IPC TM-650 2. 4. 9

(3) Glass transition temperature (Tg): measured by thermal mechanical analysis

### Example 1

24.6 g (0.06 mole) of BAPP and 160 g of NMP were charged into a 4-neck reaction vessel equipped with a stirrer and a nitrogen inlet, and then mixed with stirring at a nitrogen flow rate of 20 cc/min and at a temperature of 15□ until BAPP is completely dissolved. Four flasks, each equipped with a stirring bar were used. To the first flask, 2.94 g (0.01 mole) of BPDA and 10 g of NMP were charged and mixed with stirring until BPDA is completely dissolved. To the second flask, 1.34 g of PBTDA (0.0025 mole) and 10 g of NMP were charged and mixed with stirring until PBTDA is completely dissolved. The solutions in the first flask and the second flask were added into the above reaction vessel, and reaction was conducted for 1 hour with stirring in a nitrogen atmosphere.

To the third flask, 3.1 g (0.01 mole) of ODPA and 10 g of NMP were charged and mixed with stirring until ODPA is completely dissolved. The solution in the third flask was added into the reaction vessel, and then reaction was conducted for 1 hour with stirring in a nitrogen atmosphere.

12.08 g (0.0375 mole) of BTDA and 50 g of NMP were charged into the fourth flask and then mixed with stirring until BTDA is completely dissolved. Subsequently, ¼ of the solution of the fourth flask was added into the reaction vessel every 30 minutes, and then reaction was conducted at a temperature of 15° C. in a nitrogen atmosphere for 4 hour. Polyamic acid resin was obtained.

Supply of nitrogen was stopped and the reaction vessel was equipped with a Dean stark for removing water. 35 g of toluene was charged into the reaction vessel, and then the temperature was raised up to 185° C. to initiate imidization of polyamic acid resin, thereby forming polyimide resin. Water was removed by azeotropic reflux with toluene. When no water was brought out, the temperature was lowered to room temperature. Methanol was added to the reaction mixture to precipitate the resulting polyimide resin. The precipitate was filtered, washed with methanol two times, and dried in an oven. Polyimide resin powder was thus obtained.

0.5 g of polyimide resin was dissolved in 15 g of N-methyl-2-pyrrolidone (NMP) and the intrinsic viscosity (IV) of the solution, measured with a viscosity meter at 25° C., is 1.16 dl/g.

### Examples 2 to 10

The steps of Example 1 were repeated, except the monomers were used in an amount (expressed by mole) specified in Table 1.

### Comparative Examples 1 to 2

The steps of Example 1 were repeated, except monomers were used in an amount (expressed by mole) specified in Table 1.

TABLE 1

| | Exam- | Exam- | Exam- | | | | | | | | Com- | Com- |
|---|---|---|---|---|---|---|---|---|---|---|---|---|
| | ple | ple | ple | Example | Example | Example | Example | Example | Example | Example | parative | parative |
| | 1 | 2 | 3 | 4 | 5 | 6 | 7 | 8 | 9 | 10 | Example 1 | Example 2 |
| BPDA | 0.01 | 0.01 | 0.01 | 0.01 | 0.01 | 0.01 | 0.01 | 0.01 | 0.01 | 0.01 | 0.01 | 0.040 |
| BTDA | 0.075 | 0.07 | 0.065 | 0.060 | 0.075 | 0.07 | 0.07 | 0.07 | 0.07 | 0.07 | 0.08 | 0.050 |
| ODPA | 0.01 | 0.01 | 0.01 | 0.01 | 0.01 | 0.01 | 0.01 | 0.01 | 0.01 | 0.01 | 0.01 | 0.01 |
| PBTDA | 0.005 | 0.01 | 0.015 | 0.02 | | | 0.01 | 0.01 | 0.01 | 0.01 | | |
| BHEBPDA | | | | | 0.005 | 0.01 | | | | | | |
| BAPP | 0.1 | 0.1 | 0.1 | 0.1 | 0.1 | | | | | | 0.1 | 0.1 |
| BAPB | | | | | | 0.1 | | | | | | |
| BAPS | | | | | | | 0.1 | | | | | |
| BAPS-M | | | | | | | | 0.1 | | | | |
| TPE-R | | | | | | | | | 0.1 | | | |
| APB | | | | | | | | | | 0.1 | | |
| Intrinsic | 1.16 | 0.97 | 1.25 | 1.31 | 0.92 | 0.85 | 0.93 | 1.22 | 0.95 | 0.83 | 0.92 | 1.13 |
| viscosity | | | | | | | | | | | | |
| (dl/g) | | | | | | | | | | | | |

The polyimide resins obtained from the above Examples 1 to 10 and Comparative examples 1 to 2 were dissolved in the solvents as listed in Table 2, respectively, and the solubility thereof in these solvents was measured. The results were given in Table 2.

TABLE 2

| | Exam- | Exam- | Exam- | | | | | | | | | |
|---|---|---|---|---|---|---|---|---|---|---|---|---|
| | ple | ple | ple | Example | Example | Example | Example | Example | Example | Example | Comparative | Comparative |
| | 1 | 2 | 3 | 4 | 5 | 6 | 7 | 8 | 9 | 10 | Example 1 | Example 2 |
| NMP | + | + | + | + | + | + | + | + | + | + | + | * |
| DMAC | + | + | + | + | + | + | + | + | + | + | * | * |
| DMF | + | + | + | + | + | + | + | + | + | + | − | − |

“+” represents soluble; “−” represents insoluble; “*” represents soluble after heating.

The powder of polyimide resins obtained from Examples 1 to 10 and Comparative examples 1 to 2 were respectively dissolved in NMP to formulate varnishes. The varnish was then applied on the two sides of a 25 μm polyimide film (Tradename: Apical) to form each side a 3 μm thick and dried by heating at 150° C. for 5 minutes and at 180° C. for 15 minutes in an oven. After drying, the polyimide film with double sides coated with polyimide resin and two copper foils were laminated by a plate press or a roller press at a temperature of 280° C. to 400° C., preferably 300° C. to 360° C., under a pressure of 20 to 200 kg/cm², preferably 40 to 150 kg/cm². A double-sided copper foil wiring board was obtained, and the peeling strength of copper foil was measured according to the IPC TM-650 standards. The results were given in Table 3.

TABLE 3

| | Exam- | Exam- | | | | | | | | | Com- | Com- |
|---|---|---|---|---|---|---|---|---|---|---|---|---|
| | ple | ple | Example | Example | Example | Example | Example | Example | Example | Example | parative | parative |
| | 1 | 2 | 3 | 4 | 5 | 6 | 7 | 8 | 9 | 10 | Example 1 | Example 2 |
| Tg (° C.) | 234 | 243 | 247 | 235 | 234 | 226 | 235 | 225 | 228 | 238 | 236 | 247 |
| Peeling | 1.1 | 1.1 | 1.3 | 1.2 | 1.4 | 1.3 | 1.2 | 1.4 | 1.7 | 1.4 | 0.8 | 0.7 |
| strength | | | | | | | | | | | | |
| (kgf/cm) | | | | | | | | | | | | |
| Solder | Pass | Pass | Pass | Pass | Pass | Pass | Pass | Pass | Pass | Pass | Pass | Pass |
| float | | | | | | | | | | | | |
| resistance | | | | | | | | | | | | |
| test | | | | | | | | | | | | |
| (288° C. | | | | | | | | | | | | |
| 10 sec) | | | | | | | | | | | | |

From the results in Table 3, it can be seen that a double-sided copper foil wiring board by using the polyimide resin of the present invention as the adhesive has higher peeling strength (over 1.0 kgf/cm) than those of comparative examples.

The examples described hereinabove merely illustrate the principles and effects of the present invention and should not be considered as a limitation for the present invention. Any persons skilled in the art may make modifications and variations without departing from the spirit and scope of the present invention. The scope of the present invention should be defined by the following claims.

What is claimed is:

1. A soluble polyimide resin, prepared by
polycondensating a dianhydride monomer including at least a dianhydride represented by formula (I) 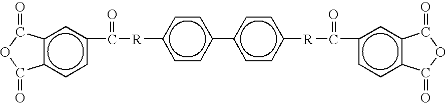
wherein R is O or O(CH₂)ₙO, n is an integer of 1 to 2
and a diamine monomer including at least a diamine represented by formula (II)
H₂N—Ar—NH₂ (II)
wherein Ar is an aromatic group selected from the following: 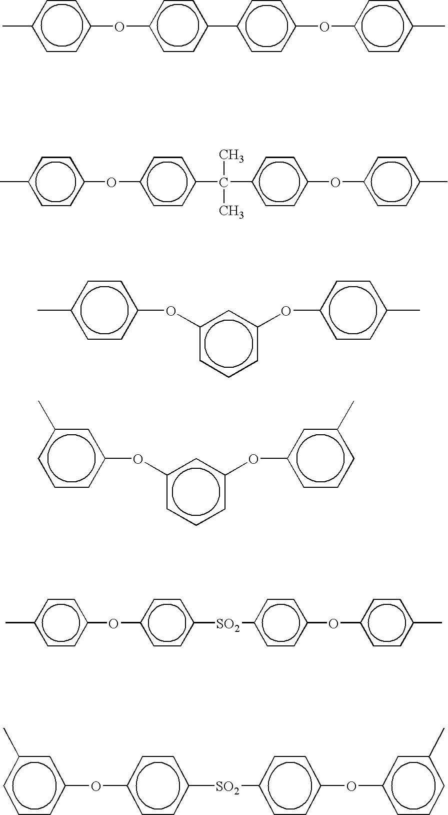
to form a polyamic acid resin, then imidizing the resulting polyamic acid resin to form a polyimide resin.

2. The polyimide resin according to claim 1, wherein R is O or O(CH₂)₂ O.

3. The polyimide resin according to claim 1, wherein the molar ratio of the dianhydride monomer and the diamine monomer is 0.75 to 1.25.

4. The polyimide resin according to claim 3, wherein the molar ratio of the dianhydride monomer and the diamine monomer is 0.9 to 1.1.

5. The polyimide resin according to claim 1, wherein the dianhydride monomer further comprises 3,3′,4,4′-benzophenonetetracarboxylic dianhydride, 3,3′,4,4′-biphenyltetracarboxylic dianhydride, and 4,4′-oxydiphthalic dianhydride.

6. The polyimide resin according to claim 5, wherein the dianhydride monomer comprises 5 to 20 mol % of dianhydride represented by formula (I), 60 to 80 mol % of 3,3′,4,4′-benzophenonetetracarboxylic dianhydride, 10 to 20 mol % of 3,3′,4,4′-biphenyltetracarboxylic acid and 5 to 15 mol % of 4,4′-oxydiphthalic dianhydride monomer, based on the total moles of dianhydride monomer.

7. An adhesive comprising a varnish prepared by dissolving a polyimide resin according to claim 1 in an aprotic solvent.

8. The adhesive according to claim 7, wherein the aprotic solvent is at least one eselected from the group consisting of N-methyl-2-pyrrolidone, dimethylacetamide and dimethylformamide.

9. A method for preparing a flexible printed circuit board by using the adhesive according to claim 7, comprising the steps of:
a) applying the adhesive according to claim 7 on a metal foil;
b) removing the solvent by heating to form an adhesive layer; and
c) curing the adhesive layer by heating in a nitrogen atmosphere.

10. The method according to claim 9, further comprising, before the step c), a step of laminating another metal foil on the adhesive layer in such a manner that the adhesive layer is positioned between the two metal foils, thereby forming a double-sided flexible printed circuit board having a metal foil—adhesive layer—metal foil structure.

11. The method according to claim 9, wherein the metal foil is selected from the group consisting of a copper foil, an aluminum foil, a nickel foil, and a composite foil thereof.

12. A method for preparing polyimide resin, comprising the steps of:
polycondensating a dianhydride monomer including at least a dianhydride represented by formula (I) 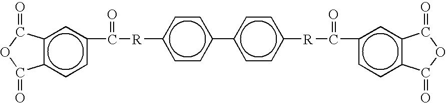
wherein R is O or O(CH2)ₙO, n is an integer of 1 to 2 and a diamine monomer including at least a diamine represented by formula (II)
H₂N—Ar—NH₂ (II)
wherein Ar is an aromatic group selected from the following: 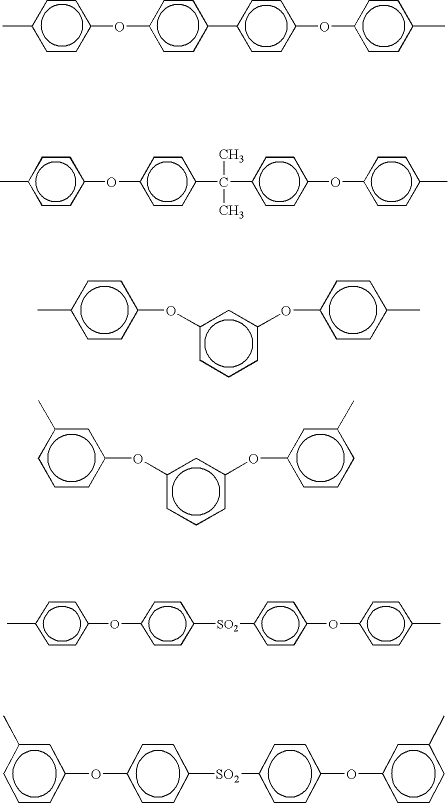
In an aprotic solvent, to form a polyamic acid resin; and
(b) imidizing the polyamic acid resin in step (a) to form a polyimide resin.

13. The method according to claim 12, wherein R is O or O(CH₂)ₙO.

14. The method according to claim 12, wherein the molar ratio of the dianhydride monomer and the diamine monomer is 0.75 to 1.25.

15. The method according to claim 14, wherein the molar ratio of the dianhydride monomer and the diamine monomer is 0.9 to 1.1.

16. The method according to claim 12, wherein the dianhydride monomer further comprises 3,3′,4,4′-benzophenonetetracarboxylic dianhydride, 3,3′,4,4′-biphenyltetracarboxylic dianhydride, and 4,4′-oxydiphthalic dianhydride.

17. The method according to claim 16, wherein the dianhydride monomer comprises 5 to 20 mol % of dianhydride represented by formula (I), 60 to 80 mol % of 3,3′,4,4′-benzophenonetetracarboxylic dianhydride, 10 to 20 mol % of 3,3′,4,4′-biphenyltetracarboxylic acid and 5 to 15 mol % of 4,4′-oxydiphthalic dianhydride monomer, based on the total moles of dianhydride monomer.

18. The method according to claim 12, wherein the aprotic solvent is selected from the group consisting of N-methyl-2-pyrrolidone, dimethylacetamide, dimethylformamide and a mixture thereof.

19. The method according to claim 18, wherein an organic solvent selected from the group consisting of benzene, toluene, cyclohexanol and a mixture thereof, is added to the aprotic solvent.

20. The method according to claim 12, wherein imidization in the step (b) is performed at a temperature of 100 to 450° C.
